(19) United States
(12) Patent Application Publication
(10) Pub. No.: US 2025/0079479 A1
(43) Pub. Date: Mar. 6, 2025

(54) GAS TURBINE AND FUEL CELL BASED POWER GENERATOR

(71) Applicant: Honeywell International Inc., Charlotte, NC (US)

(72) Inventors: Martin Knob, Charlotte, NC (US); Rebecca Kamire, Charlotte, NC (US); Jan Ludvik, Charlotte, NC (US)

(21) Appl. No.: 18/458,920

(22) Filed: Aug. 30, 2023

(51) Int. Cl. H01M 8/0267; F02C 6/00

(52) U.S. Cl. CPC H01M 8/0267; F02C 6/00; B64D 2041/005; F05D 2220/50; H01M 2250/20

(57) ABSTRACT

A power generation system includes a ram channel and a fuel cell. The fuel cell includes a compressor, a fuel cell cathode coupled to receive compressed air from the compressor, and a fuel cell return line having a first end coupled to receive compressed air from the fuel cell and a second end coupled to provide the compressed air to the ram channel.

### BACKGROUND

A system for power generation may include both a fuel cell and a gas turbine. Gas turbines are typically used in vehicle based applications, such as aircraft, where airflow from movement of the vehicle assists with power generation by the gas turbine. When the vehicle is stopped or moving slowly, the fuel cell can produce power for use by the vehicle. If powerful enough, it may serve as the main propulsion energy source.

Some proton exchange membrane (PEM) based fuel cells produce heat that needs to be removed from the fuel cell. The heat generated by the fuel cell is usually at a significantly lower temperature than the temperatures present in gas turbines. Such fuel cells may require separate, heavy heat exchangers, which can add weight and aerodynamic drag to a vehicle.

### SUMMARY

A power generation system includes a ram channel and a fuel cell. The fuel cell includes a compressor, a fuel cell cathode coupled to receive compressed air from the compressor, and a fuel cell return line having a first end coupled to receive compressed air from the fuel cell and a second end coupled to provide the compressed air to the ram channel.

### BRIEF DESCRIPTION OF THE DRAWINGS

FIG. 1 is a block schematic diagram of an improved power generation system that includes a fuel cell according to an example embodiment.

FIG. 2 is a flowchart illustrating an example method for operating the mixed power generation system of FIG. 1.

FIG. 3 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

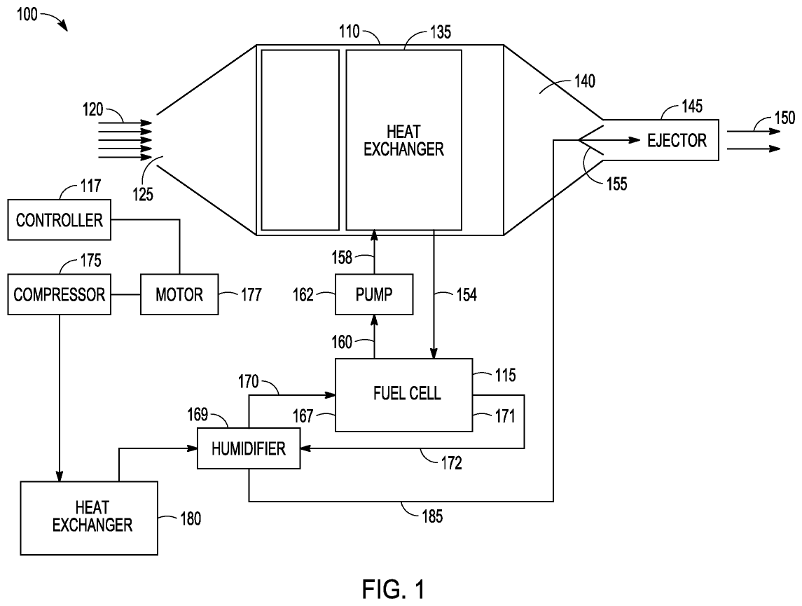

FIG. 1 is a block schematic diagram of an improved system 100. System 100 may include a propulsion device 110 and fuel cell 115 that generates electrical power for one or more elements of system 100, such as an electric motor for propulsion device 110, avionics of an aircraft that includes system 100, or other electrical loads of the aircraft, such as defrost functions and cabin air compression. A controller 117 may be coupled to control various components in the power generation system 100. The propulsion device 110 operates based on receiving airflow 120 at a diffuser opening 125.

A ram channel 140 that includes a heat exchanger 135 and includes or is coupled to an ejector 145, that exhausts the airflow at 150, which can contribute to propulsion in some example vehicles or at least reduce drag created by the diffuser opening in general. A throttling device 155 may be included in the ram channel 140 near a beginning of the ejector 145. The ejector 145 utilizes the pressurized outlet from a cathode of the fuel cell 115 as a motive flow, thereby increasing the total pressure downstream of the heat exchanger 135 and hence decreasing the overall pressure drop of the ram channel 140.

The fuel cell 115 may be a high temperature PEM fuel cell that generates heat during the generation of electricity by combining hydrogen and oxygen. The fuel cell 115 may power the propulsion device 110 in one example. In further examples, the propulsion device 110 may be separately powered. The fuel cell 110 is coupled to the heat exchanger 135 via a coolant circulation loop 158 that include a first leg 160 with a pump 162 to provide coolant to the heat exchanger 135 and a second, return leg 165 to provide the coolant back to the fuel cell 115 to cool the fuel cell 115. The circulation loop 158 and heat exchanger 135 provide liquid loop cooling, vapor cooling, or vapor compression cooling of the fuel cell 115 assisted by means of the pump 162 and controller 117.

Fuel cell 115 includes a cathode inlet side 167 to receive humidified gas from a humidifier 169 via a supply line 170, and a cathode outlet side 171 to provide humidified exhaust from the fuel cell back to the humidifier 169 via a return line 172, also referred to as an outlet. Humidifier 169 may be a membrane humidifier such as a flat sheet or hollow fiber membrane humidifier.

In one example, the gas provided to the fuel cell 115 is compressed via a compressor 175 and motor 187 coupled to compressor 175. The compressed gas from compressor 175 may be provided to an optional heat exchanger 180, which provides the compressed gas to the humidifier 169. Heat exchanger 180 may be optional in some applications provided heat exchanger 135 provides sufficient fuel cell 115 cooling. In one example, the gas is compressed to at least twice atmospheric pressure or higher. The gas remains at a pressure elevated from ambient as it progresses through the fuel cell 115 and back to the humidifier 169 via return line 172. The humidifier 169 both recirculates humidity back to the anode side 167 and exhausts drier gas via an exhaust line 185, which may be thought of as an extension of the return line 172.

In one example, the gas in the exhaust line 185 is also at a higher pressure and is provided to the throttling device 155 at the ejector 145. Alternatively, gas from return line 172 may be provided directly to exhaust line 185, bypassing humidifier 169.

The throttling device 155, also referred to as a nozzle, changes pressure energy of the gas in the exhaust line 185 into kinetic energy. The throttling device 155 may be controlled via controller 117 to exhaust the gas from exhaust line 185 in the same direction as the airflow 150, serving to reduce ram air drag caused by the ejector 145. Various pressure and temperature sensors may also be included to provide input to controller 117 for use in controlling one or more of the components of system 100.

The throttling device may comprise curved plates that are controllably spaced. The curved plates may be brought closer together to increase exhaust velocity or further apart to decrease exhaust velocity to optimize the reduction in drag. In one example, controller 117 may include a computing device programmed to control the throttling device 155 to implement PID (proportional/integral/derivative) control over a variety of velocities of incoming airflow 120 and fuel cell exhaust pressures. The controller 117 may also control the coolant recirculation loop to maintain the fuel cell at a proper operating temperature. In one example, the coolant is a cooling fluid that comprises a vapor and the coolant loop controls a fuel cell operating temperature of about 79.4° C.

In the case of use of system 100, overall drag of the system 100 is decreased due to the addition of the exhaust gas from the exhaust line 185.

In one example, the gas in exhaust line 185 may be used as motive force for coolant in the cooling air in the ram channel 158.

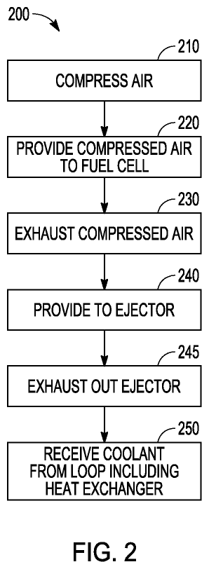

FIG. 2 is a flowchart illustrating a method 200 for operating the mixed power generation system 100. Method 200 begins at operation 210 by compressing air. Compressed air is provided at operation 220 to a fuel cell for generation of electricity. Operation 230 receives exhausted air from the fuel cell which is still compressed compared to ambient air pressure. The compressed exhausted air is provided at operation 240 to an ejector of a ram channel of a gas turbine. The compressed exhausted air is exhausted out the ejector at operation 245 to reduce overall drag.

In one example, the exhausted air from the fuel cell is first provided to a humidifier to capture humidity from the exhausted air. The compressed air from operation 210 is also first provided to the humidifier to be humidified by the captured humidity from the exhausted air before being provided to the fuel cell.

At operation 250, the fuel cell receives coolant from a coolant recirculation loop coupled to heat exchanger to cool the fuel cell. Various operations of method 200, such as control of the compressor and coolant recirculation may be performed by controller 117 in one example.

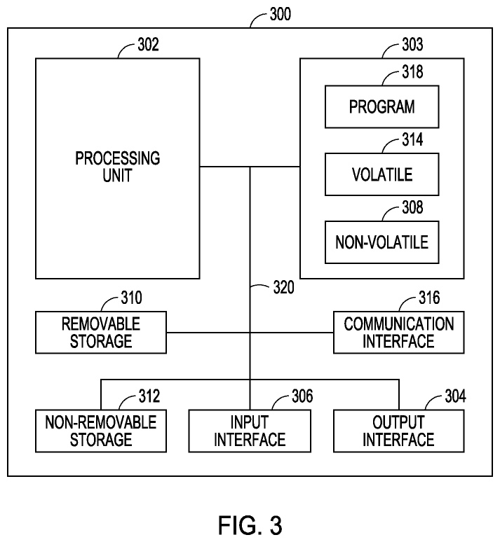

FIG. 3 is a block schematic diagram of a computer system 300 to implement the controller 117 and for performing methods and algorithms according to example embodiments. All components need not be used in various embodiments.

One example computing device in the form of a computer 300 may include a processing unit 302, memory 303, removable storage 310, and non-removable storage 312. Although the example computing device is illustrated and described as computer 300, the computing device may be in different forms in different embodiments. For example, the computing device may instead be a smartphone, a tablet, smartwatch, smart storage device (SSD), or other computing device including the same or similar elements as illustrated and described with regard to FIG. 3. Devices, such as smartphones, tablets, and smartwatches, are generally collectively referred to as mobile devices or user equipment.

Although the various data storage elements are illustrated as part of the computer 300, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 303 may include volatile memory 314 and non-volatile memory 308. Computer 300 may include—or have access to a computing environment that includes—a variety of computer-readable media, such as volatile memory 314 and non-volatile memory 308, removable storage 310 and non-removable storage 312. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 300 may include or have access to a computing environment that includes input interface 306, output interface 304, and a communication interface 316. Output interface 304 may include a display device, such as a touchscreen, that also may serve as an input device. The input interface 306 may include one or more of a touchscreen, touchpad, mouse, keyboard, camera, one or more device-specific buttons, one or more sensors integrated within or coupled via wired or wireless data connections to the computer 300, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 300 are connected with a system bus 320.

Computer-readable instructions stored on a computer-readable medium are executable by the processing unit 302 of the computer 300, such as a program 318. The program 318 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 318 along with the workspace manager 322 may be used to cause processing unit 302 to perform one or more methods or algorithms described herein.

### EXAMPLES

1. A power generation system includes a ram channel and a fuel cell. The fuel cell includes a compressor, a fuel cell cathod coupled to receive compressed air from the compressor, and a fuel cell return line having a first end coupled to receive compressed air from the fuel cell and a second end coupled to provide the compressed air to the ram channel.

2. The system of example 1 wherein the second end of the fuel cell return line is coupled to provide the compressed air to a throttling device coupled to an ejector in the ram channel.

3. The system of any of examples 1-2 wherein the compressor compresses air to at least two times ambient pressure.

4. The system of any of examples 1-3 and further including a humidifier coupled between the first end of the return line and the ram channel, the humidifier including a humidified air outlet coupled to provide humidified air to the cathode of the fuel cell.

5. The system of any of examples 1-4 and further including a coolant loop coupled to circulate cooling fluid between the fuel cell and a heat exchanger of the propulsion device.

6. The system of example 5 wherein the cooling fluid includes a vapor and the coolant loop controls a fuel cell operating temperature of about 79.4° C.

7. The system of any of examples 1-6 wherein the fuel cell includes a high temperature proton exchange membrane (PEM) fuel cell.

8. The system of any of examples 1-7 and further including a controller coupled to control a throttling device coupled to the second end of the fuel call return line.

9. The system of example 8 wherein the throttling device includes curved plates and wherein the controller controls a distance between the curved plates to control exhaust velocity.

10. A fuel cell system including a compressor, a fuel cell coupled to receive compressed air from the compressor, and a fuel cell return line having a first end coupled to receive compressed air from a cathode of the fuel cell and a second end coupled to provide the compressed air to a ram channel.

11. The fuel cell system of example 10 wherein the second end of the fuel cell return line is coupled to provide the compressed air to a throttling device coupled to an ejector in a ram channel of the propulsion device.

12. The fuel cell system of any of examples 10-11 wherein the compressor compresses air to at least two times ambient pressure.

13. The fuel cell system of any of examples 10-12 and further including a humidifier coupled between the return line and the ram channel, the humidifier including a humidified air outlet coupled to provide humidified air to the cathode of the fuel cell.

14. The fuel cell system of any of examples 10-13 and further including a controller coupled to control a throttling device coupled to the second end of the fuel call return line.

15. The fuel cell system of example 14 wherein the throttling device includes curved plates and wherein the controller controls a distance between the curved plates to control exhaust velocity.

16. The fuel cell system of any of examples 10-15 and further including a coolant loop coupled to circulate cooling fluid between the fuel cell and a heat exchanger of the gas turbine.

17. The fuel cell system of example 16 wherein the cooling fluid includes a vapor and the coolant loop controls a fuel cell operating temperature of about 79.4° C.

18. The fuel cell system of any of examples 10-17 wherein the fuel cell includes a high temperature proton exchange membrane (PEM) fuel cell.

19. A method of operating a power generation system includes compressing air, providing compressed air to a fuel cell cathode, receiving exhausted compressed air from the cathode of the fuel cell, providing the exhausted compressed air to an ejector, and exhausting the exhausted compressed air out of the ejector to reduce overall drag.

20. The method of example 19 and further including receiving coolant at the fuel cell from a recirculating coolant loop that includes a heat exchanger.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A power generation system comprising:
a ram channel; and
a fuel cell comprising:
a compressor;
a fuel cell cathode coupled to receive compressed air from the compressor; and
a fuel cell return line having a first end coupled to receive compressed air from the fuel cell and a second end coupled to provide the compressed air to the ram channel.

2. The system of claim 1 wherein the second end of the fuel cell return line is coupled to provide the compressed air to a throttling device coupled to an ejector in the ram channel.

3. The system of claim 1 wherein the compressor compresses air to at least two times ambient pressure.

4. The system of claim 1 and further comprising a humidifier coupled between the first end of the return line and the ram channel, the humidifier including a humidified air outlet coupled to provide humidified air to the cathode of the fuel cell.

5. The system of claim 1 and further comprising a coolant loop coupled to circulate cooling fluid between the fuel cell and a heat exchanger of a propulsion device.

6. The system of claim 5 wherein the cooling fluid comprises a vapor and the coolant loop controls a fuel cell operating temperature of about 79.4° C.

7. The system of claim 1 wherein the fuel cell comprises a high temperature proton exchange membrane (PEM) fuel cell.

8. The system of claim 1 and further comprising a controller coupled to control a throttling device coupled to the second end of the fuel call return line.

9. The system of claim 8 wherein the throttling device comprises curved plates and wherein the controller controls a distance between the curved plates to control exhaust velocity.

10. A fuel cell system comprising:
a compressor;
a fuel cell coupled to receive compressed air from the compressor; and
a fuel cell return line having a first end coupled to receive compressed air from a cathode of the fuel cell and a second end coupled to provide the compressed air to a ram channel.

11. The fuel cell system of claim 10 wherein the second end of the fuel cell return line is coupled to provide the compressed air to a throttling device coupled to an ejector in the ram channel.

12. The fuel cell system of claim 10 wherein the compressor compresses air to at least two times ambient pressure.

13. The fuel cell system of claim 10 and further comprising a humidifier coupled between the return line and the ram channel, the humidifier including a humidified air outlet coupled to provide humidified air to the cathode of the fuel cell.

14. The fuel cell system of claim 10 and further comprising a controller coupled to control a throttling device coupled to the second end of the fuel call return line.

15. The fuel cell system of claim 14 wherein the throttling device comprises curved plates and wherein the controller controls a distance between the curved plates to control exhaust velocity.

16. The fuel cell system of claim 10 and further comprising a coolant loop coupled to circulate cooling fluid between the fuel cell and a heat exchanger of the gas turbine.

17. The fuel cell system of claim 16 wherein the cooling fluid comprises a vapor and the coolant loop controls a fuel cell operating temperature of about 79.4° C.

18. The fuel cell system of claim 10 wherein the fuel cell comprises a high temperature proton exchange membrane (PEM) fuel cell.

19. A method of operating a power generation system, the method comprising:
compressing air;
providing compressed air to a fuel cell cathode;
receiving exhausted compressed air from the cathode of the fuel cell;
providing the exhausted compressed air to an ejector; and
exhausting the exhausted compressed air out of the ejector to reduce overall drag.

20. The method of claim 19 and further comprising:
receiving coolant at the fuel cell from a recirculating coolant loop that includes a heat exchanger.
